(19) United States
(12) Patent Application Publication
(10) Pub. No.: US 2024/0413596 A1
(43) Pub. Date: Dec. 12, 2024

(54) PLUG CONNECTOR WITH OUTER CONDUCTOR PART WITH INWARDLY OFFSET PLATEAUS

(71) Applicant: Robert Karst GmbH & Co. KG, Berlin (DE)

(72) Inventors: Joachim Kunze, Panketal (DE); Jan Kirchhoff, Berlin (DE)

(21) Appl. No.: 18/702,753

(22) PCT Filed: Oct. 11, 2022
(86) PCT No.: PCT/EP2022/078289

§ 371 Date: Apr. 18, 2024

(30) Foreign Application Priority Data
Oct. 19, 2021 (DE) 10 2021 211 805.4

(51) Int. Cl. H01R 24/40; H01R 43/20

(52) U.S. Cl. CPC H01R 24/40; H01R 43/20

(57) ABSTRACT

Plug connectors include a housing made of electrically insulating material; an outer conductor part, which is arranged inside the housing and is formed in a portion as a hollow cylinder or is formed entirely as a hollow cylinder; an inner conductor part, which is arranged at least partially inside the outer conductor part; and an insulating part, which is arranged at least partially inside the outer conductor part and at least partially encloses the inner conductor part. The outer conductor part in the interior of the hollow cylinder has exactly two opposing spines, each of which has a plateau offset inwards with respect to an inner wall of the hollow cylinder.

### REFERENCE TO RELATED APPLICATION

The present application claims the priority benefit of International Patent Application No. PCT/EP21/78289 filed Oct. 11, 2022, and hereby incorporates the same application herein by reference in its entirety.

### FIELD OF INVENTION

The invention relates to a plug connector, in particular a high-frequency plug connector, which has an outer conductor part with stamped portions. In addition, an assembly comprising the plug connector and a complementary plug connector is proposed. A method for producing the plug connector is also provided. A method for producing the assembly is also described.

### BACKGROUND

Conventional plug connectors have an outer conductor part in the form of a sleeve that is intended for electrical contact with the outer conductor of a coaxial cable. The outer conductor part is plugged together with a complementary outer conductor part of a complementary plug connector. In conventional FAKRA-compliant plug connectors, the outer conductor part has a plurality of spring tongues that are separated by slots. When the complementary outer conductor part of the complementary plug connector, which is formed as a hollow cylinder for example, is inserted, the spring tongues are expanded and enclose and hold the complementary outer conductor part.

The disadvantage of such a design is that when lateral tension is applied to the outer conductor part, these spring tongues may expand or bend open and the mechanical hold and contact between the two outer conductor parts is impaired or lost. In the worst-case scenario, the connection—in particular this may mean the electrical connection and/or the mechanical connection—between the outer conductor parts due to the mechanical effect is severed.

The object of the invention is to provide a solution to this problem.

### SUMMARY

The invention basically provides to a plug connector, an assembly and methods as laid down in the independent claims. Further embodiments are subject matter of dependent claims, the following description and the examples.

A plug connector, in particular a high-frequency plug connector, is proposed in accordance with the invention, comprising
a housing made of electrically insulating material,
an outer conductor part, which is arranged inside the housing and is formed in a portion as a hollow cylinder or is formed entirely as a hollow cylinder,
an inner conductor part, which is arranged at least partially inside the outer conductor part,
an insulating part which is arranged at least partially inside the outer conductor part and at least partially encloses the inner conductor part,
wherein the outer conductor part inside the hollow cylinder has exactly two opposing spines, each of which has a plateau offset inwards in relation to an inner wall of the hollow cylinder.

It has been shown that, with the plug connector according to the invention, transverse forces—such as those that occur during FAKRA inclined tension tests-may be absorbed particularly well, and bending of the outer conductors and/or damage to the contacts may be avoided or largely avoided when forces occur in practice, especially during installation and cable laying. This is achieved by oval-like deformations of the hollow cylinder and of a complementary outer conductor part offset from each other at an angle of 90 degrees or approximately 90 degrees, when the plug connector according to the invention is considered in an assembly with the complementary plug connector. This means that the deformations of the complementary outer conductor part in relation to the deformations of the hollow cylinder are offset by 90 degrees or approximately 90 degrees in the direction of revolution. These oval-like deformations are achieved because, in accordance with an essential basic concept of the invention, exactly two plateaus (no more and no less) are provided, so that, as a consequence, the advantages according to the invention are achieved. cl DETAILED DESCRIPTION

In the following, features are sometimes described in the singular, e.g. “the recess” or “the plateau”. Such a description alternatively or additionally also includes a corresponding disclosure for a plurality of such features, if present.

The term “at least in part” has the same meaning as “wholly or partially”.

The transverse direction is the direction transverse to the centre longitudinal axis (also middle longitudinal axis) of the hollow cylinder. The centre longitudinal axis of the hollow cylinder is the axis of symmetry of the hollow cylinder, i.e. the axis of symmetry of the rotationally symmetrical cylinder, which is a portion of the outer conductor part.

The spines are a (integral) part of the outer conductor part. The spines are opposite each other in relation to the centre longitudinal axis of the hollow cylinder. In other words, a first spine is located on a first side of the centre longitudinal axis (laterally relative to the centre longitudinal axis), and at a distance from the centre longitudinal axis, and a second spine is located on a second side of the centre longitudinal axis, likewise at a distance from the centre longitudinal axis. Exactly two spines are provided.

The spines are arranged inside (in the interior of) the hollow cylinder, wherein the hollow cylinder is a portion of the outer conductor part or forms the outer conductor part. In other words, the spines are formed on the inner side of the hollow cylinder or extend on the inner side of the hollow cylinder. In other words, the spines are formed on the inner wall of the hollow cylinder or extend on the inner wall of the hollow cylinder. In other words, the spines are formed on the inner side of the lateral surface of the hollow cylinder or extend on the inner side of the lateral surface of the hollow cylinder. The spines are raised from the inner side of the lateral surface of the hollow cylinder. The spines are raised in an inward direction. The spines are raised from the inner wall of the hollow cylinder.

The spines may run in or along the transverse direction. The spines may have an extent in the longitudinal direction to produce the plateaus. In particular, the spines may have a greater extent in the transverse direction than in the longitudinal direction. However, it is not ruled out that the spines may have a greater extent in the longitudinal direction than in the transverse direction.

The longitudinal direction is a direction parallel to or aligned with the centre longitudinal axis of the hollow cylinder.

The spines are preferably point-symmetrical with respect to a point on the centre longitudinal axis of the hollow cylinder, or preferably mirror-symmetrical with respect to a mirror plane in which the centre longitudinal axis lies.

The shortest distance between the spines is preferably the shortest distance between the plateaus.

The plateaus run inside the hollow cylinder.

The plateaus may also be referred to as (e.g. indented or inwardly offset) surface portions or (e.g. indented or inwardly offset) flat wall portions of the hollow cylinder. The plateaus may be formed in particular on the inner wall of the hollow cylinder. The plateaus may each connect the highest—i.e. furthest inwards-points of the spine. The highest points (i.e. those furthest inwards in a direction of revolution of the hollow cylinder) of the spine are the highest points that result from cross-sections through the spine. A cross-section through the spine is preferably parallel to the centre longitudinal axis of the hollow cylinder in a plane which has a direction along the centre longitudinal axis of the hollow cylinder as its normal direction, that is to say lies transverse or orthogonal to the centre longitudinal axis. The above also applies to cross-sections through the hollow cylinder in general. An infinite number of highest points may potentially be defined.

In one embodiment, one or both plateaus extend flat when viewed in the transverse direction. Non-straight, e.g. curved, shapes, for example along a virtual solid cylinder or a virtual solid cylinder lateral surface, the centre longitudinal axis of which may lie in the centre longitudinal axis of the hollow cylinder, are also possible. One or both plateaus may each correspond to surface portions of the virtual solid cylinder or the virtual solid cylinder lateral surface. The surface portions may then have extents in the longitudinal direction and in the transverse direction. When talking about a virtual solid cylinder, a virtual solid cylinder lateral surface may be meant.

One or both plateaus may or may each have an extent in the direction of revolution of, e.g., 10-120 degrees. Further lower limits may be 20, 30, 40 or 50 degrees. Further upper limits may be 100, 90, 80 or 70 degrees. Preferably, the extent is between 30-90 degrees, particularly preferably between 40-80 degrees or alternatively between 50-70 degrees or alternatively between 55-65 degrees. A particularly preferred single value for the extent in the direction of revolution is 60 degrees. A particularly preferred single value for the extent in the direction of revolution for a single plateau is 60 degrees. The extent in the direction of revolution may be understood as a size and/or extent of revolution of a plateau defined by an angle. For example, an extent of 60 degrees can be understood as an extent that extends along one sixth of an entire 360-degree revolution.

A spine may be formed around the plateau—i.e. on an outer contour of the plateau-for example continuously rising or sharp (e.g. step-like or edge-like). A spine may be more or less sharp around the plateau or more or less step-like or continuously rising. In particular, a spine may comprise the plateau and the outer contour or may consist of the plateau and the outer contour.

The spines may be formed by reshaping the lateral surface of the hollow cylinder. The lateral surface may be reshaped where the spines are formed, i.e. it deviates from its original cylinder lateral surface shape. In other words, the spines may be moulded in the cylinder lateral surface. For example, the spines may be beads formed in the lateral surface of the hollow cylinder or may be formed by such beads. The spines may also, for example, comprise moulded surfaces or stamped impressions in the lateral surface of the hollow cylinder or may be formed by shaping or stamping. The spines may be produced using a mandrel.

In one embodiment, the outer conductor part has two opposing recesses (or beads or moulded surfaces or stamped impressions) on an outer side of a lateral surface of the hollow cylinder, through which the spines are formed or are formed or shaped on the inside or on the inner wall. Viewed from the outside, there is therefore a recess which corresponds to a spine when viewed from the inside. In this embodiment, the spines are formed by reshaping, as described with reference to a method. However, the invention is not limited to this.

The recesses deepen into the interior of the hollow cylinder.

The aforementioned recesses are preferably point-symmetrical with respect to a point on the centre longitudinal axis of the hollow cylinder, or preferably mirror-symmetrical with respect to a mirror plane in which the centre longitudinal axis lies.

Viewed from the outside, the recesses may form channels or grooves (each of which also has an extent orthogonal to the direction in which the respective groove extends), which run in a transverse direction. The channels or grooves may, for example, be pointed or curved in a transverse direction. Viewed from the outside, the recesses may also form or have inwardly offset surfaces or impressions.

In one embodiment, the plateaus have a minimum spacing of 90 to 98%, preferably 94to 96%, particularly preferably 94.4 to 95.6% of the inner diameter of the hollow cylinder.

In one embodiment, the plateau of at least one of the spines (or both spines), in its course (in each case, if applicable), has a portion in the form of an outwardly bulging cylinder lateral surface segment, or the plateau of at least one of the spines (or both spines) has (in each case, if applicable), the form of an outwardly bulging cylinder lateral surface segment. The outwards direction is the direction starting from the centre longitudinal axis of the hollow cylinder in the direction of the lateral surface of the hollow cylinder. In this embodiment, the cylinder lateral surface segment is visible when looking in the direction along the centre longitudinal axis of the hollow cylinder, with curvature outwards, i.e. away from the centre longitudinal axis. The cylinder lateral surface segment or both cylinder lateral surface segments may be part of a virtual solid cylinder or solid cylinder lateral surface of which the diameter is smaller than the diameter of the hollow cylinder.

In a more specialised embodiment, the plateaus of both spines have a portion in the form of an outwardly bulging cylinder lateral surface segment in their respective course or the plateaus of both spines each have the shape of an outwardly bulging cylinder lateral surface segment, wherein the cylinder lateral surface segments are both part of a virtual solid cylinder or solid cylinder lateral surface. In other words, the cylinder lateral surface segments may in particular each be part of the same virtual solid cylinder or solid cylinder lateral surface.

In one embodiment, the virtual solid cylinder (or solid cylinder lateral surface) lies concentrically within the hollow cylinder of the outer conductor part, wherein the centre longitudinal axis of the virtual solid cylinder (or solid cylinder lateral surface) lies in the centre longitudinal axis of the hollow cylinder. A constantly wide (virtual) gap is thus formed between the virtual solid cylinder (or solid cylinder lateral surface) and the inner wall of the hollow cylinder. This embodiment enables a particularly concentric insertion of a complementary outer conductor of a complementary plug, in particular a cylindrical complementary outer conductor.

In one embodiment, the virtual solid cylinder (or solid cylinder lateral surface) has a diameter, which is 90 to 98%, preferably 94-96% of the inner diameter of the hollow cylinder.

In a special embodiment, the hollow cylinder does not have a slot extending in the longitudinal direction. In particular, in an even more specialised embodiment, the hollow cylinder does not have spring tongues as known from the prior art.

This increases the strength and, in particular, the fatigue strength of the hollow cylinder and of a plug connection with a complementary outer conductor part.

In one embodiment, the plateau of at least one of the spines has an extent along a transverse direction of the hollow cylinder and an extent along a longitudinal direction of the hollow cylinder, wherein the extent along the transverse direction is greater than the extent along the longitudinal direction.

The longitudinal direction may correspond to a centre longitudinal direction of the hollow cylinder. The transverse direction may extend transversely to the centre longitudinal direction. In particular, the plateau may extend in the direction of revolution on the inner wall of the hollow cylinder and may have a greater extent in the direction of revolution (along the transverse direction) than in the longitudinal direction. This means that the plateau may have a shape in particular similar to that of a strip or an oval or an oval with tapered end regions in its width (similarly, for example, to an externally visible contour of a human eye) along the direction of revolution or along the transverse direction. The extent in the longitudinal direction may change along the transverse direction. For example, the plateau may have a smaller longitudinal extent in outer transverse regions and a larger longitudinal extent in inner transverse regions. This embodiment is advantageous because it is easy to produce and offers particularly high stability when subjected to transverse forces.

In one embodiment, the plateau of at least one of the spines inside the hollow cylinder has a convex contour which extends at least partially in an arc along a transverse direction of the hollow cylinder.

The contour can in particular be convex in such a way that a central part of the contour or of a portion of the contour or of a flank of the contour-viewed in the transverse direction-is located closer to a plug-side end of the inner wall than parts of the contour spaced from the central part. In particular, the contour may be, for example, oval-like or oval-like with tapered end regions.

For example, if the contour has the shape of an oval or an oval with tapered end regions (similarly to a contour of a human eye visible from the outside), a long portion of the oval or a portion between the tapered end regions may extend in the transverse direction and/or in the direction of the direction of revolution.

In particular, the contour may slope inwards from the inner wall of the hollow cylinder in the form of a continuous gradient or in the form of an incline.

The presented embodiment offers the advantage that a particularly simple assembly with a complementary outer conductor part may be achieved and the machine-based and/or automated processability is improved. During an insertion process, the outermost edge of the complementary outer conductor part may first touch a central part of the convex contour (viewed in the transverse direction) and then only come into contact with the outer parts of the contour as the insertion process continues. The insertion force required to insert the complementary outer conductor part may thus build up slowly and continuously.

In a further aspect, the invention relates to an assembly comprising the plug connector according to the invention and a complementary outer conductor part of a complementary plug connector,

wherein the complementary outer conductor part has a complementary cylindrical portion which is at least partially inserted into the hollow cylinder of the plug connector, wherein the complementary cylindrical portion is in pressure contact with the plateaus and the complementary cylindrical portion is compressed along an axis extending between the plateaus.

The hollow cylinder may additionally be widened along this axis. In particular, the axis may be a transverse axis in relation to the plug connector according to the invention. The axis may be orthogonal to the centre longitudinal axis of the hollow cylinder.

The complementary cylindrical portion is created by pressure applied via the plateaus of the hollow cylinder on the complementary cylindrical portion, so that the diameter of the complementary cylindrical portion is compressed between the plateaus. If the diameter of the complementary cylindrical portion is considered orthogonal to the axis between the plateaus (i.e. at a 90-degree angle to this axis), then it may be (and usually is in practice) widened. The pressure causes a force of the hollow cylinder on the complementary portion. The force may be a spring force or may be understood as a spring force.

The hollow cylinder, which has the spines with the plateaus, is widened by (counter) pressure acting on the plateaus from the complementary cylindrical portion. If the diameter of the hollow cylinder is considered orthogonal to the axis between the plateaus (i.e. at a 90-degree angle to this axis), then it may be (and usually is, in practice) compressed.

The axis is to be understood as a virtual axis and may be defined, for example, by the centre point of one plateau and the centre point of the other plateau. The axis may cross the centre longitudinal axis of the hollow cylinder orthogonally. A compression along an axis may mean a reduction in diameter of the complementary cylindrical portion when its diameter is viewed in the axial direction. A widening along an axis may mean an increase in the diameter of the hollow cylinder, when its diameter is considered in the axial direction.

The aforementioned compression and expansion of both the hollow cylinder and the complementary cylindrical portion creates a firm and stable bond between the hollow cylinder and the complementary plug connector. The assembly process can be automated particularly simple and easily due to the resultant self-centring effect and the occurring forces, which may act in accordance with a spring force. Since neither the hollow cylinder nor the complementary plug connector have any interruptions, for example by means of slots or spring tongues, the assembly according to the invention may withstand transverse forces particularly well. The advantages of the plug connector according to the invention apply accordingly.

The fact that the complementary outer conductor part is at least partially “introduced” into the hollow cylinder of the plug connector may mean in particular that the complementary outer conductor part is inserted into it and/or arranged in it and/or surrounded by it.

The assembly may alternatively or additionally comprise the plug connector according to the invention and a complementary outer conductor part of a complementary plug connector, wherein the complementary outer conductor part has a complementary cylindrical portion that is at least partially inserted into the hollow cylinder of the plug connector,

wherein the complementary cylindrical portion is in pressure contact with the plateaus and the complementary cylindrical portion is deformed in a cross-section in the manner of a first oval such that a narrow diameter of the first oval extends between the plateaus, wherein the hollow cylinder is deformed in the cross-section in the form of a second oval such that a wide diameter of the second oval extends between the plateaus. The deformations do not have to correspond here to exact ovals.

Oval-like deformations, for example, are sufficient, i.e. deformations that roughly correspond to ovals.

In a further aspect, the invention relates to a method for producing a plug connector according to the invention, or a component for such a plug connector, comprising the steps of
providing an outer conductor part which is formed as a hollow cylinder in one portion,
moulding two opposing recesses in the outer side of the lateral surface of the hollow cylinder, wherein exactly two spines extending inside the hollow cylinder are formed, each of which has an inwardly offset plateau with respect to an inner wall of the hollow cylinder,
assembling the outer conductor part, the housing, the inner conductor part and the insulating part to form the plug connector or the component.

Additional parts may be added during the assembly to form the plug connector.

The method may relate to the assembly of a component that may be supplemented or assembled with other parts or components to form a plug connector.

The method may be used to produce any plug connectors according to the invention that are structurally described above. The features of the embodiments or method features described above may be the subject of the method according to the invention. With regard to the method according to the invention, reference is made in full to the embodiments of the plug connector according to the invention, and vice versa.

In a special variant, the method comprises the steps of: introducing or inserting a moulding tool into the hollow cylinder and reshaping one or both of the spines in such a way that the plateau of the respective spine, in its course, develops a portion in the form of an outwardly bulging cylinder lateral surface segment or the plateau has the form of an outwardly bulging cylinder lateral surface segment.

In a further aspect, the invention relates to a method for producing an assembly according to the invention, comprising the steps of:
providing the plug connector according to the invention;
providing a complementary plug connector with a complementary outer conductor part having a complementary cylindrical portion;
inserting the complementary cylindrical portion at least partially into the hollow cylinder of the plug connector, wherein the complementary cylindrical portion is brought into pressure contact with the plateaus and the complementary cylindrical portion is compressed along an axis extending between the plateaus.

The hollow cylinder may additionally be widened along the axis.

The method may be used to produce any embodiments of the assembly according to the invention (in particular with any embodiments of the plug connector according to the invention that are structurally described above. Previously described features of the embodiments presented or previously described method features of the method for producing the plug connector may be the subject of the method according to the invention. With regard to the method according to the invention, full reference is made to the embodiments of the plug connector according to the invention and the assembly according to the invention, and vice versa.

### BRIEF DESCRIPTION OF THE DRAWINGS

In the following, the invention is described by means of exemplary embodiments, in which:

FIG. 1: shows a schematic view of a plug connector according to the invention;

FIG. 2: shows a schematic view of another plug connector according to the invention;

FIG. 3: shows a schematic view of a detail of the plug connector according to the invention shown in FIG. 1;

FIG. 4: shows a perspective view of an outer conductor part according to the prior art;

FIG. 5: shows a schematic perspective view of an outer conductor part-according to the invention;

FIG. 6 shows a schematic side view of the outer conductor part shown in FIG. 5-according to the invention;

FIG. 7: shows the outer conductor part shown in FIG. 5 and FIG. 6-according to the invention, in a lateral, schematic view; rotated by 90 degrees around the centre longitudinal axis compared to the view shown in FIG. 6;

FIG. 8: shows a schematic longitudinal sectional view of the outer conductor part shown in FIG. 5-7-according to the invention, in schematic form;

FIG. 9: shows the outer conductor part shown in FIG. 5-8-according to the invention, in schematic longitudinal sectional view, rotated by 90 degrees about the centre longitudinal axis compared to the view in FIG. 8;

FIG. 10: shows the outer conductor part shown in FIG. 5-9-according to the invention, in schematic cross-sectional view in the perspective shown in FIG. 6 through the section C-C;

FIG. 11: shows a schematic view of an assembly of an outer conductor part according to the invention and a complementary outer conductor part;

FIG. 12: shows a schematic sectional view (section A-A) of the assembly shown in FIG. 11 before final fitting;

FIG. 13 shows a schematic sectional view (section A-A) of the assembly shown in FIG. 11-12 in the final fitting (corresponding to the perspective shown in FIG. 12);

FIG. 14 shows a schematic longitudinal sectional view of the assembly shown in FIG. 11-13.

Identical reference signs used in different drawings signify identical features, even if not all features shown by reference signs are discussed for each drawing.

### EXAMPLES AND ILLUSTRATIVE EMBODIMENTS

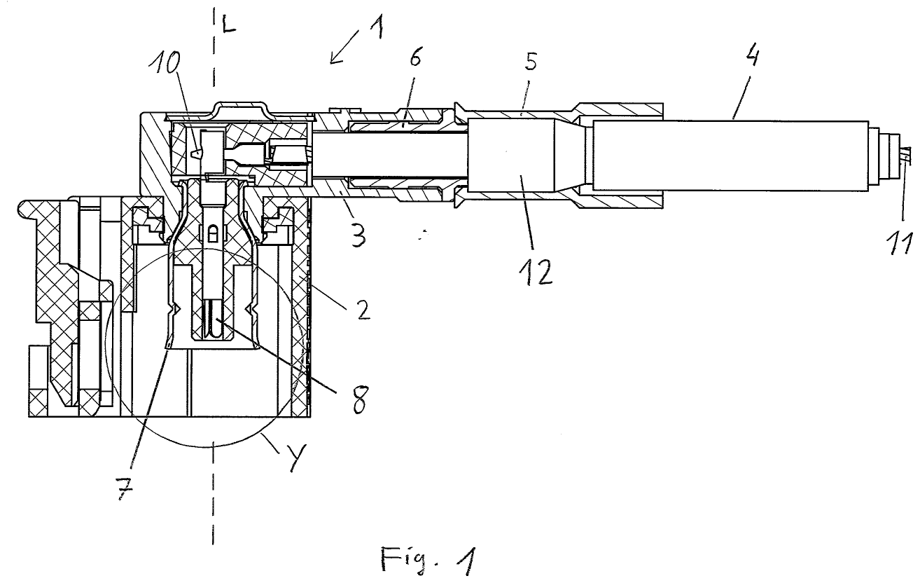

FIG. 1 shows a plug connector 1 according to the invention, which in this case is an angled plug connector. However, the invention is not limited to angled plug connectors. The plug connector 1 has a housing 2 made of plastic. A main body 3, for example a die-cast zinc part, is rotatably mounted in the housing and is rotatable about the longitudinal axis L. A cable 4 runs transversely, i.e. at an angle, to the longitudinal axis L, and is guided through sleeves 5, 6 and is connected to the main body 3 by these sleeves.

Inside the housing 2 there is an outer conductor part 7, an inner conductor part 8 and an insulating part 9. The inner conductor part 8, in this case a female inner conductor part, is electrically contacted with the inner conductor 11 of the cable 4 via the mandrel 10. The outer conductor part 7 is electrically contacted via the main body 3 and the conductive sleeves 6 and 5 to a shielding 12, which is shown here stylised in a fanned-out state.

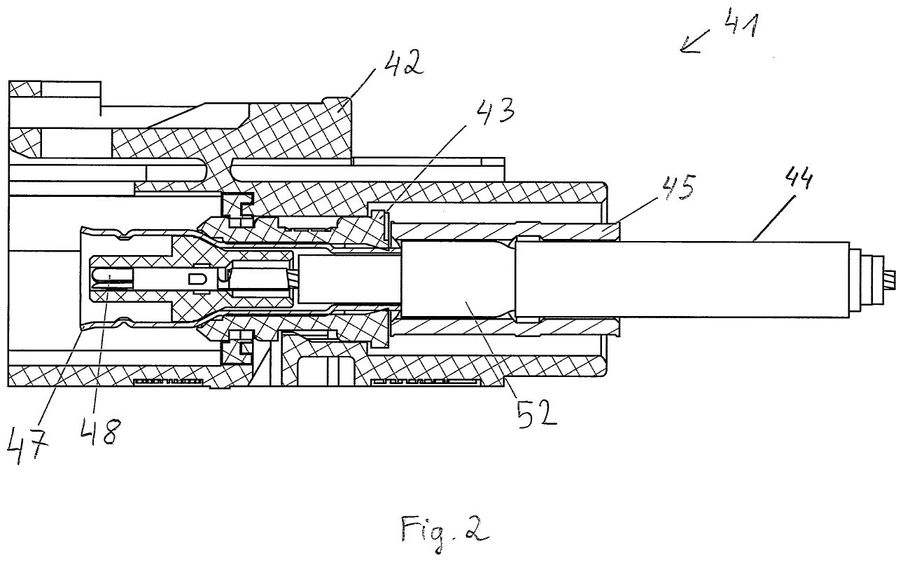

FIG. 2 shows a plug connector 41 according to the invention, which in this case is not an angled plug connector, but a straight plug connector. The invention is not limited to straight plug connectors. The plug connector 41 has a housing 42 made of plastic. A main body 43 is mounted in the housing. A cable 44 is guided through a sleeve 45.

Inside the housing 42 there is an outer conductor part 47 and a female inner conductor part 48, which is electrically contacted with the inner conductor of the cable 4. The outer conductor part 47 is electrically contacted via the conductive sleeve 45 to a shielding 52, which is shown here stylised in a fanned-out state.

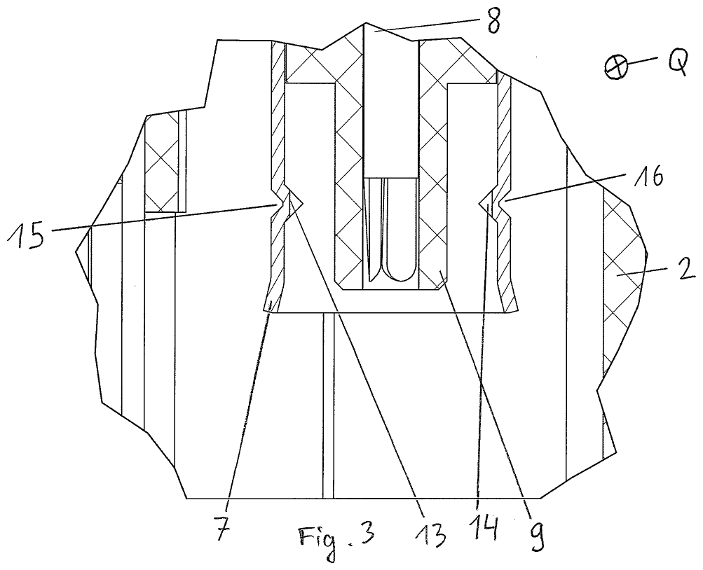

FIG. 3 shows the detail Y from FIG. 1. The spines 13, 14, provided here with reference signs, are formed by shapings in the outer conductor part 7. On the outer side of the outer conductor part 7, recesses 15, 16 are stamped, whereby mentioned spines 13, 14 are formed on the inner side. The spines 13, 14 run along a transverse direction Q (and in the direction of revolution), which here runs in the viewing direction of the observer. The structure of the spines and recesses is described in greater detail with reference to the following figures.

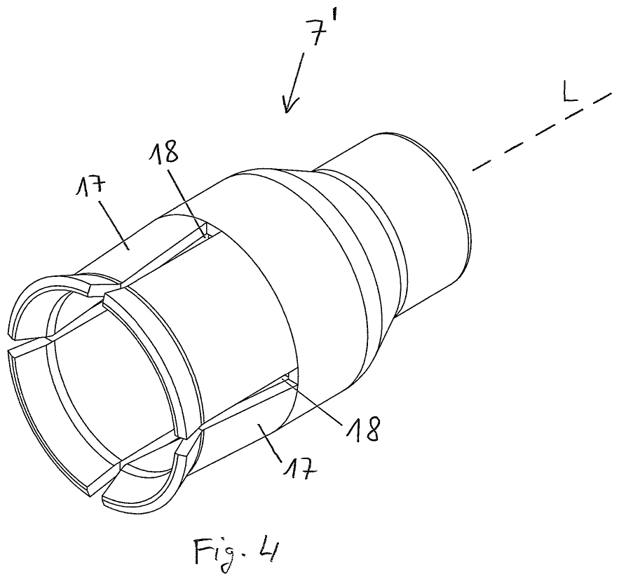

Firstly, FIG. 4 shows an outer conductor part 7′ according to the prior art. This outer conductor part 7′ has four spring tongues 17, which are separated from each other by slots 18 running in the longitudinal direction L.

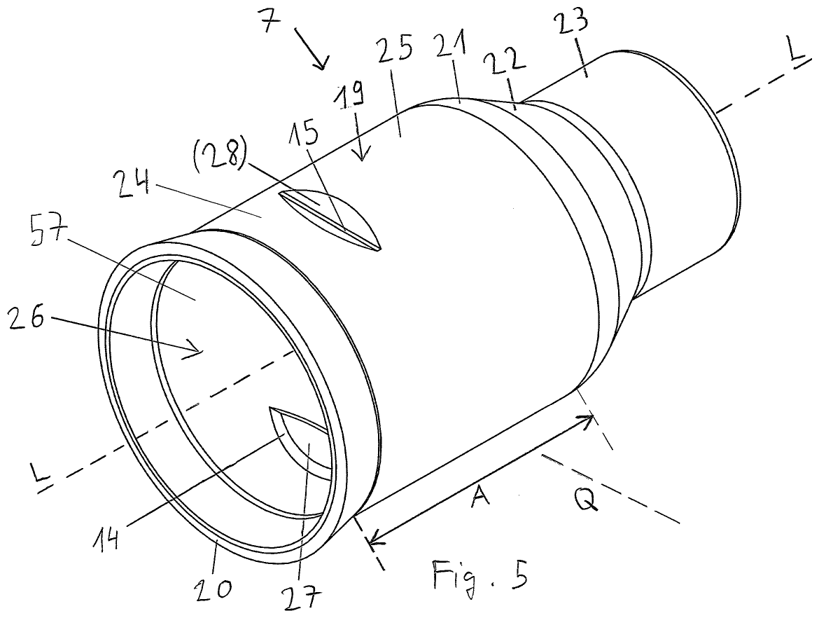

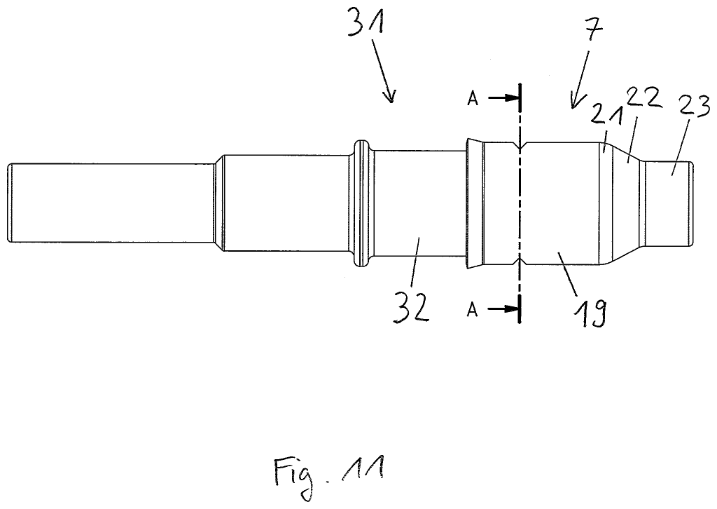

By contrast, FIG. 5 shows an outer conductor part 7 as used in the plug connector 1 according to the invention and already shown in FIGS. 1 and 3. The outer conductor part 7 is formed as a hollow cylinder 19 in portion A. In the longitudinal direction L, a widened part 20 adjoins at the front, on the opening side. This is where a complementary outer conductor 31 of a mating plug connector (see FIG. 11) is inserted.

In the other direction, the hollow cylinder 19 is adjoined by further portions 21, 22, 23 that gradually narrow.

The hollow cylinder 19 has the lateral surface 24, as well as the outer side 25 and the inside (interior) 26. The lateral surface 24 has an inner wall 57.

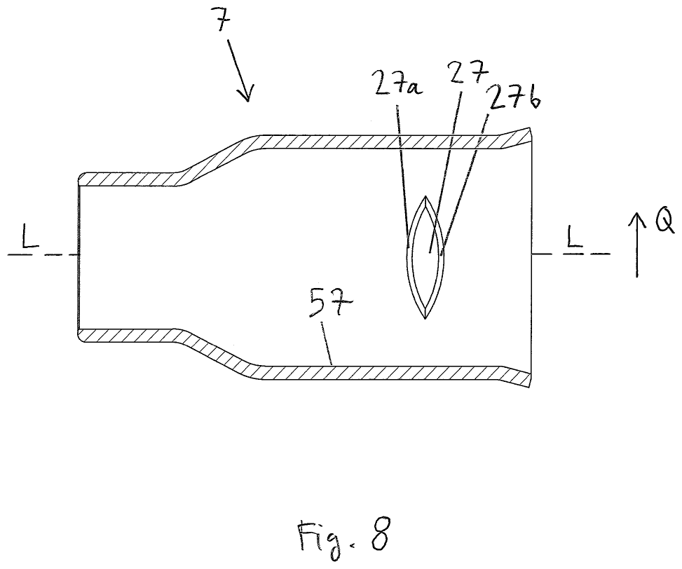

The perspective view shows the recess 15, through which the spine 13 (shown in FIG. 2) is formed, and the spine 14, which is formed by the recess 16 (shown in FIG. 2). A plateau 27 is provided on the spine 14 (as part of the spine 14), which extends to a greater extent along the transverse direction Q (and in the direction of revolution). The plateau 27 also has a smaller extent in the longitudinal direction L, said extent being variable along the transverse direction Q. The plateau 27 has a shape and a contour that is oval-like with tapered end regions. The spines 13, 14 each have the plateau 27, 28 and the outer contour (more precisely: contour regions 27a, 27b, 28a, 28b, cf. FIG. 8) of the respective plateau 27, 28.

In this case, the transverse direction Q is exactly perpendicular to the longitudinal direction L, wherein the state of being at right angles is not mandatory according to the invention. Furthermore, the plateau 27 extending symmetrically along the transverse direction Q in this exemplary embodiment may also be uneven or asymmetrical. A plateau 28 of the spine 13 is shown with a reference sign in parentheses because the plateau 28 runs in the interior 26, like the opposite plateau 27, and is not visible from the outside.

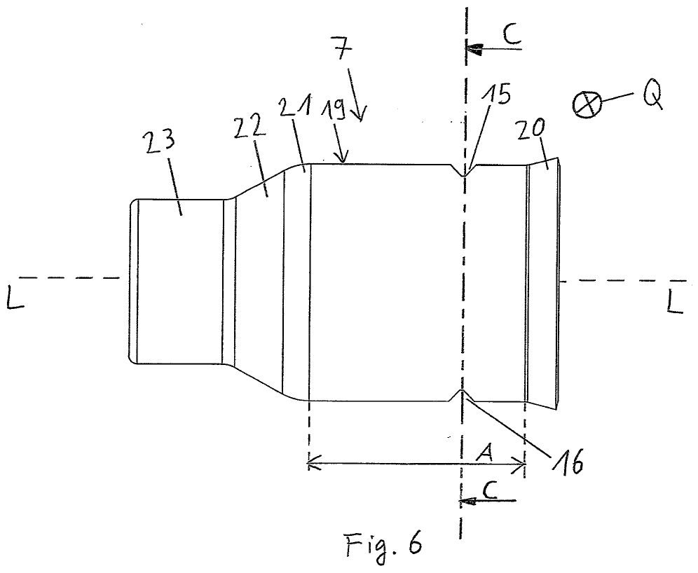

FIG. 6 shows a side view in comparison to the perspective view of FIG. 5. The transverse direction Q is in the viewing direction of the observer. The recesses 15, 16 each have a small, flat longitudinal portion extending in the longitudinal direction and which is surrounded on both sides by inclines.

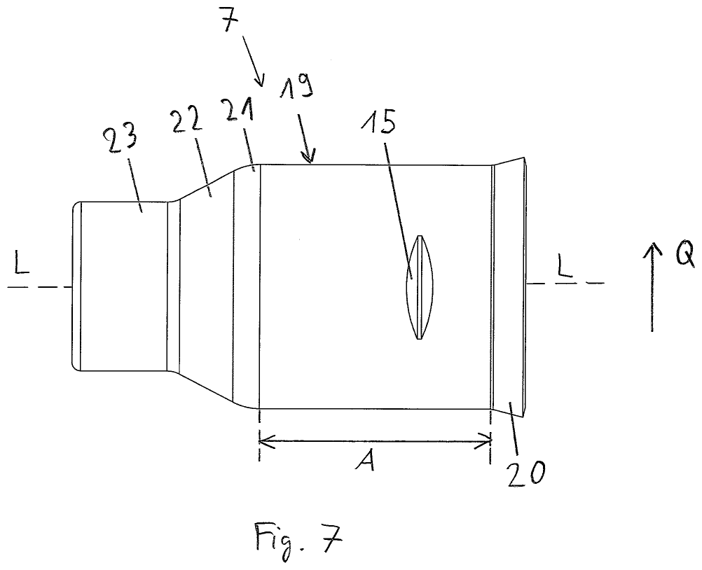

FIG. 7 shows a further view of the outer conductor part 7 according to the invention. The recess 15 is shown in a plan view-that is, the outer conductor part 7 in FIG. 7 is rotated by 90 degrees about the longitudinal direction L (which corresponds to the direction of the centre longitudinal axis of the outer conductor part 7) compared to FIG. 6. The recess 15 (and also the recess 16, not shown) has, similarly to the plateaus 27, 28, an oval-like outer contour with tapered end regions, wherein a strip-like surface region or impression extending along the transverse direction Q is provided (e.g. impressed or stamped) in the centre of the recess.

FIG. 8 shows the outer conductor part 7 shown in FIG. 6-7 in longitudinal sectional view.

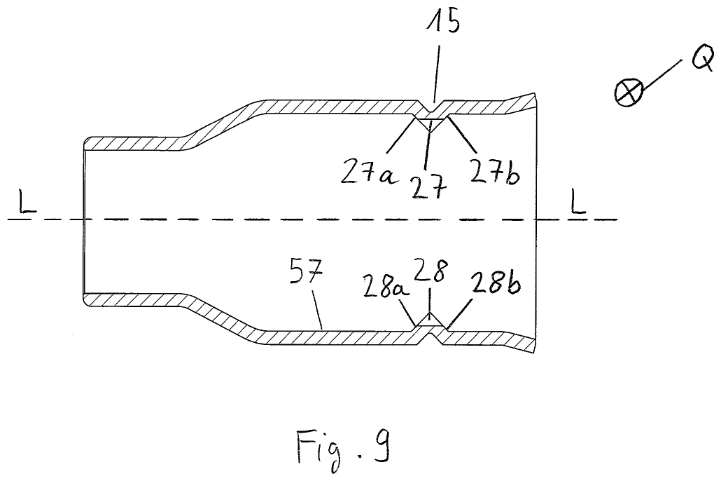

The plateau 27 is visible in plan view. Contour regions 27a and 27b extend continuously inwards from the inner wall 57 of the outer conductor part 7. This is also shown in FIG. 9, which shows the outer conductor part 7 in a longitudinal section rotated by 90 degrees compared to FIG. 8. The contour regions 27a and 27b rise continuously in the direction of the centre of the plateau 27. The same applies to the plateau 28, which has contour regions 28a and 28b. Both plateaus are symmetrical with respect to the centre longitudinal axis of the outer conductor part 7 (or a longitudinal plane that contains the centre longitudinal axis and runs orthogonally to an imaginary connection between the plateaus 27, 28).

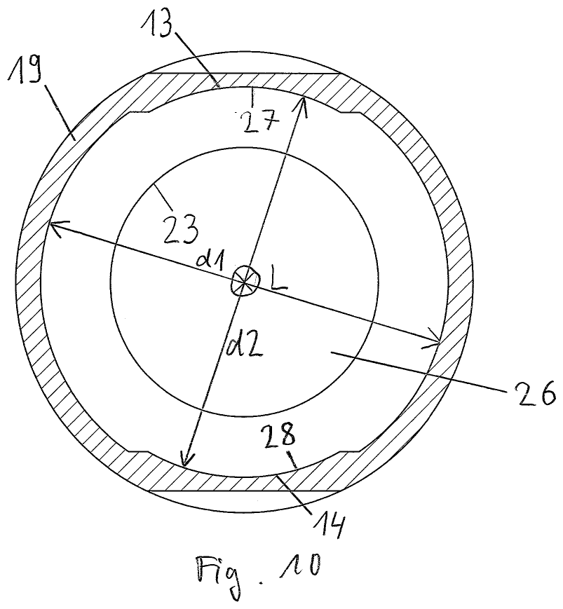

FIG. 10 shows a cross-section along the line C-C from FIG. 6. The section passes exactly through the deepest regions of the recesses 15, 16 and exactly in the centre through the plateaus 27, 28, which lie exactly in the sectional plane. It is shown in particular in FIG. 10 that the plateaus 27, 28 each have the shape or course of an outwardly bulging cylinder lateral surface segment. These cylinder lateral surface segments lie on the same virtual solid cylinder (or solid cylinder lateral surface), not shown here, which is arranged concentrically and on the same centre longitudinal axis to the hollow cylinder 19 and has a smaller diameter than the hollow cylinder 19 (and its inner wall 57). The cylinder lateral surface segments each have a radius of curvature, which corresponds to the radius of curvature of the virtual solid cylinder (or solid cylinder lateral surface).

The inner diameter of the hollow cylinder 19 is labelled d1. The diameter of the virtual solid cylinder (or solid cylinder lateral surface) is labelled d2.

The cylinder lateral surface segments may be obtained by inserting or introducing a cylindrical shaping tool, not shown here, into the centre of the outer conductor part 7 of FIG. 10 in the longitudinal direction L, said tool having the diameter d2 of the virtual solid cylinder (or solid cylinder sheath).

FIG. 11 shows an assembly of the outer conductor part 7 and a complementary outer conductor part 31 of a complementary plug connector. Neither the plug connector 1 nor the complementary plug connector and their other components are shown here, but only the assembly of the outer conductor part 7 with the complementary outer conductor part 31. The complementary cylindrical portion 32 of the complementary outer conductor part 31 is inserted into the outer conductor part 7 and into its hollow cylinder 19.

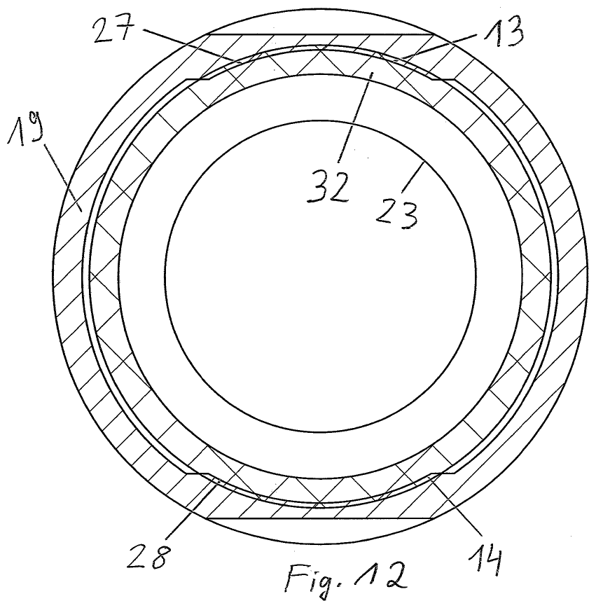

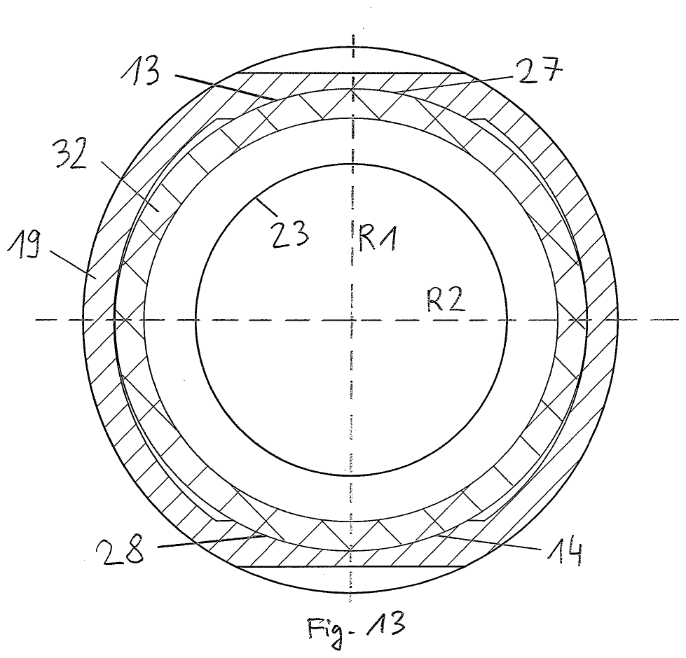

FIGS. 12 and 13 each show a section along line A-A in FIG. 11. FIG. 12 shows that the outer diameter of the complementary cylindrical portion of the complementary outer conductor part 31 is larger than the diameter d2 of the virtual solid cylinder (or solid cylinder lateral surface) shown in FIG. 7. By reshaping the cylindrical portion 32, by reshaping the spines 13, 14 and their plateaus 27, 28 and/or by reshaping the cylinder 19, the actual state shown in FIG. 13 is achieved, in which the complementary cylindrical portion 32 is inserted as far as possible into the hollow cylinder 19 and has a firm, flat pressure contact to the spines 13, 14 on its outer side, whereby a stable plug-in connection is produced.

In one direction or one axis R1 between the plateaus 27, 28, the cylinder 19 20 is widened, the complementary cylindrical portion 32 is compressed in this direction. In a direction orthogonal to the direction between the plateaus 27, 28 in the plane of FIG. 13, on the other hand, the cylinder 19 is reduced in diameter (compressed) and the complementary cylindrical portion 32 is widened. This results in oval-like deformations of both the cylinder 19 and the complementary cylindrical portion 32.

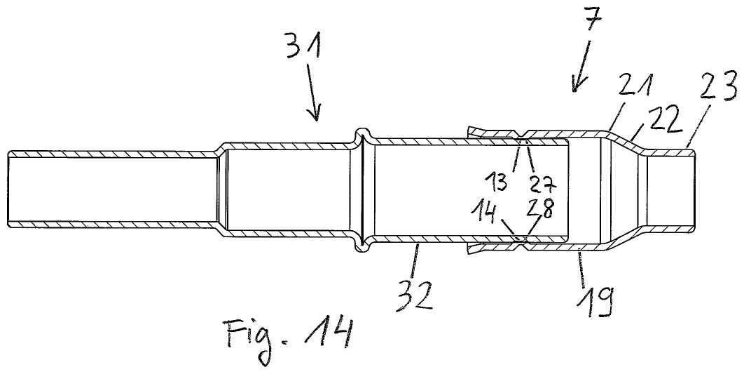

FIG. 14 shows a longitudinal section of the assembly shown in FIG. 11-13.

### List of Reference Signs

1 plug connector
2 housing
3 main body
4 cable
5 sleeve
6 sleeve
7 outer conductor part
7′ outer conductor part according to the prior art
8 inner conductor part
9 insulating part
10 mandrel
11 inner conductor
12 shielding
13 spine
14 spine
15 recess
16 recess
17 spring tongue
18 slot
19 hollow cylinder
20 widened part
21 narrowing portion
22 narrowing portion
23 narrowing portion
24 lateral surface
25 outer side
26 inside/inner side/interior
27 plateau
27a contour region
27b contour region
28 plateau
28a contour region
28b contour region
31 complementary outer conductor part of a complementary plug connector
32 complementary cylindrical portion
57 inner wall
A portion of the outer conductor part 7
d1 inner diameter of the hollow cylinder 19
d2 diameter of the virtual solid cylinder (or solid cylinder lateral surface)
K portion of the plateaus 27, 28
L longitudinal direction
Q transverse direction
41 plug connector
42 housing
43 main body
44 cable
45 sleeve
47 outer conductor part
48 inner conductor part
52 shielding
R1 direction/axis between the plateaus
R2 direction/axis orthogonal to the axis between the plateaus

1. A plug connector, in particular a high-frequency plug connector, comprising
a housing made of electrically insulating material,
an outer conductor part, which is arranged inside the housing and is formed in a portion as a hollow cylinder or is formed entirely as a hollow cylinder,
an inner conductor part, which is arranged at least partially inside the outer conductor part,
an insulating part, which is arranged at least partially inside the outer conductor part and at least partially encloses the inner conductor part,
wherein
the outer conductor part in the interior of the hollow cylinder has exactly two opposing spines, each of which has a plateau offset inwards with respect to an inner wall of the hollow cylinder.

2. The plug connector according to claim 1, wherein the outer conductor part, on an outer side of a lateral surface of the hollow cylinder, has two opposing recesses through which the spines are formed.

3. The plug connector according to claim 1, wherein the plateau of at least one of the spines has, in its course, a portion in the form of an outwardly bulging cylinder lateral surface segment, or wherein the plateau of at least one of the spines has the form of an outwardly bulging cylinder lateral surface segment.

4. The plug connector according to claim 1, wherein the plateaus of both spines have, in their respective course, a portion in the form of an outwardly bulging cylinder lateral surface segment, or wherein the plateaus of both spines each have the form of an outwardly bulging cylinder lateral surface segment, and wherein the cylinder lateral surface segments are both in each case part of a virtual solid cylinder.

5. The plug connector according to claim 4, wherein the virtual solid cylinder lies concentrically within the hollow cylinder, wherein the centre longitudinal axis of the virtual solid cylinder lies in the centre longitudinal axis of the hollow cylinder.

6. The plug connector according to claim 4, wherein the virtual solid cylinder has a diameter which is 90 to 98%, preferably 94 to 96%, of the inner diameter of the hollow cylinder.

7. The plug connector according to any one of the preceding claims claim 1, wherein the hollow cylinder (19) does not have a slot extending in the longitudinal direction.

8. The plug connector according to claim 1, wherein the plateau of at least one of the spines has an extent along a transverse direction of the hollow cylinder and an extent along a longitudinal direction of the hollow cylinder, wherein the extent along the transverse direction is greater than the extent along the longitudinal direction.

9. The plug connector according to one of the preceding claim 1, wherein the plateau of at least one of the spines in the interior of the hollow cylinder has a convex contour which extends at least partially in an arcuate manner along a transverse direction of the hollow cylinder.

10. An assembly comprising the plug connector according to any claim 1 and a complementary outer conductor part of a complementary plug connector, wherein the complementary outer conductor part has a complementary cylindrical portion (32) which is at least partially inserted into the hollow cylinder of the plug connector, wherein the complementary cylindrical portion is in pressure contact with the plateaus and the complementary cylindrical portion is compressed along an axis extending between the plateaus.

11. The assembly according to claim 10, characterised in thatwherein the hollow cylinder is widened along the axis.

12. A method for producing a plug connector according to any one claim 2, or a component for such a plug connector, comprising the steps of:
providing an outer conductor part which is formed as a hollow cylinder in one portion,
moulding two opposing recesses in the outer side of the lateral surface of the hollow cylinder, wherein exactly two spines extending inside the hollow cylinder are formed, each of which has an inwardly offset plateau with respect to an inner wall of the hollow cylinder,
assembling the outer conductor part, the housing, the inner conductor part and the insulating part to form the plug connector or the component.

13. The method according to claim 12, comprising the steps of:
introducing a moulding tool into the hollow cylinder and reshaping one or both of the spines in such a way that the plateau of the respective spine, in its course, develops a portion in the form of an outwardly bulging cylinder lateral surface segment or the plateau has the form of an outwardly bulging cylinder lateral surface segment.

14. The method for producing an assembly according to claim 10, comprising the steps of:
providing the plug connector according to claim 1;
providing a complementary plug connector with a complementary outer conductor part having a complementary cylindrical portion;
inserting the complementary cylindrical portion at least partially into the hollow cylinder of the plug connector, wherein the complementary cylindrical portion is brought into pressure contact with the plateaus and the complementary cylindrical portion is compressed along an axis extending between the plateaus.
